(19) United States
(12) Patent Application Publication
(10) Pub. No.: US 2018/0086873 A1
(43) Pub. Date: Mar. 29, 2018

(54) Ethoxylated Vegetable Oils in Low Density Spray Foam Formulations

(71) Applicant: Stepan Company, Northfield, IL (US)

(72) Inventors: Sarah WOLEK, Arlington Heights, IL (US); Warren A. KAPLAN, Libertyville, IL (US); Laura SCHREINER, Palatine, IL (US)

(21) Appl. No.: 15/809,090

(22) Filed: Nov. 10, 2017

Related U.S. Application Data
(63) Continuation of application No. PCT/US2016/030559, filed on May 3, 2016.
(60) Provisional application No. 62/162,438, filed on May 15, 2015.

(51) Int. Cl. C08G 18/48; C08G 18/10; C08G 18/08; C08G 18/18; C08G 18/22; C08G 18/16; C08G 18/76; C08G 18/42

(52) U.S. Cl. CPC C08G 18/4891; C08G 18/10; C08G 18/14; C08G 18/1833; C08G 2101/0083; C08G 18/163; C08G 18/7664; C08G 18/48; C08G 18/42; C08G 18/225

(57) ABSTRACT

Alkoxylated natural oils are useful for preparation of water-blown polyurethane foams and can replace polyols and emulsifiers generally used in the art to provide polyol compositions having greater shelf-stability and blend-stability. Methods for preparing polyol compositions useful for preparation of water-blown polyurethane compositions, for preparing the polyurethane compositions using the polyol compositions, and kits comprising the polyol compositions are also described.

### CROSS-REFERENCE TO RELATED APPLICATIONS

This application is a continuation of and claims priority to International application Serial No. PCT/US2016/030559 (International Publication No. WO 2016/186830), having an International filing date of May 3, 2016, which claims priority to U.S. provisional patent application Ser. No. 62/162,438, filed May 15, 2015. The entire specifications of the PCT and provisional applications referred to above are hereby incorporated by reference.

### FIELD OF THE INVENTION

The disclosure relates to polyol compositions containing alkoxylated natural oils that are useful for preparation of water-blown polyurethane compositions, methods for preparing the polyol compositions and polyurethane compositions, and kits comprising the polyol compositions.

### BACKGROUND OF THE INVENTION

In conventional polyurethane foam manufacturing methods, the isocyanate portion of a low density water-blown polyurethane (PUR) formulation is referred to as the “A-side,” while the isocyanate-reactive portion is referred to as the “B-side.” In a spray-applied PUR formulation, the A-side and the B-side are stored separately, and typically combined at the point of application through high pressure spray application equipment. The B-side typically contains water, polyol, flame retardants, antioxidants, silicone surfactants, cell openers, and other additives, all pre-mixed together. The water acts as both a chemical blowing agent by reacting with isocyanate to produce CO₂ gas, and a physical blowing agent by releasing as steam from the heat of the polyurethane and polyurea forming chemical reactions.

Relatively high percentages of water (e.g., >15 wt. %) in the B-side formulation can lead to phase instability, in which the water is no longer completely soluble in the other components of the B-side. Phase separation can become a problem for formulators who prepare, store, and ship the B-side premix in 55 gallon drums. Spray applicators in the field have no way to see inside the steel drum to visualize the phase separation, and mixing of the material in the field can be very difficult and it is always not known if complete mixing has been achieved. Phase separation of the components can lead to differences in reactivity, cell structure, physical properties as well as the consistency of the sprayed PUR foam.

To address these problems, emulsifiers have been added to the typical formulation. The prior art describes emulsifiers that are in the class of chemical compounds known as alkylphenolethoxylates. WO 00/46266 is illustrative of such emulsifiers and describes the general methods of preparing polyurethanes.

In recent years, concerns have been raised that some alkylphenolethoxylates used as emulsifiers, such as nonylphenolethoxylates (NPEs) may exhibit weak estrogen-like properties, although much weaker than naturally occurring estrogen estradiol, or may be endoaine disruptoids. While there are currently no use restrictions in the United States, NP and NPE's are being evaluated by the Environmental Protection Agency under the Chemical Action Plan (CAP) program.

Certain NPE-free emulsifiers have been used in the art, such as in WO 2012/021675, but such emulsification may still lead to B-side compositions that suffer from phase separation upon long-term storage. Often, contractors need to agitate containers of half pound foam prior to spraying to re-mix the separated components. Therefore, there remains a need in this art for spray foam formulations which are emulsifier-free and shelf-stable.

### BRIEF SUMMARY OF THE INVENTION

Alkoxylated natural oils are used for the preparation of spray polyurethane foams as a replacement for high molecular weight polyether polyols traditionally used. In particular, alkoxylated natural oils can be used as a 1:1 replacement for both the polyether polyols and the emulsifiers, such as nonylphenolethyoxylates (NPEs), in the preparation of low density spray foams. This substitution yields B-side polyol compositions that do not require emulsifiers, yet are clear and homogeneous and have an improved shelf life over polyol compositions made with standard polyols (e.g., polyether polyols). Alkoxylated natural oils also allow for greater levels of water to be added to “B-side” polyol compositions, further reducing the foam density and improving yields for the customer. Notably, alkoxylated natural oils can be used at loadings within the polyol compositions that allow the prepared polyurethane foam to meet the USDA Biopreferred Status for a “biofoam”, a growing segment of the sprayfoam industry.

Accordingly, in one aspect, this disclosure provides a polyol composition for preparing a water-blown polyurethane foam, comprising (a) a polyol component comprising a C₂₋₃alkoxylated natural oil, (b) a catalyst, and (c) a blowing agent comprising at least 50 wt. % water, wherein the polyol composition comprises at least 10 wt. % of the C₂₋₃alkoxylated natural oil.

In a further aspect, the disclosure provides a polyol composition that is shelf stable for at least 6 months in the substantial absence of emulsifiers, such as alkyl phenolethoxylates, and comprises (a) a polyol component comprising at least 15 weight % of a C₂₋₃ alkoxylated natural oil, (b) a catalyst, and (c) a blowing agent comprising at least 50 weight % water.

### BRIEF DESCRIPTION OF THE DRAWINGS

FIG. 1 shows the change in reactivity of the polyol compositions of Example 1 as measured by percent change in tack-free time (left-hand y-axis, bars) and cream time (right-hand y-axis, points). The bars are, left to right for each time point, control polyether polyol (Trial 1), Natural Oil Polyol 1 (Trial 2), and Natural Oil Polyol 2 (Trial 3).

### DETAILED DESCRIPTION OF THE INVENTION

The polyol compositions described in this application can be useful for preparing water-blown polyurethane foams. Such compositions generally comprise (a) a polyol component comprising a C₂₋₃alkoxylated natural oil, (b) a catalyst, and (c) a blowing agent comprising at least 50 wt. % water. “Water-blown” means the foam is prepared using a blowing agent that comprises water, such as water alone or water in combination with an auxiliary blowing agent, as described below, that vaporizes under the influence of the exothermic polyurethane polymerization reaction.

A “polyol” means a composition having an average hydroxyl functionality of greater than or equal to two (i.e., the composition contains, on average, greater than or equal to two hydroxyl groups per molecule of the composition). In certain embodiments, the polyol has an average functionality of greater than or equal to two and less than four, or greater than or equal to two and less than or equal to three. In certain other embodiments, each component of the polyol comprises at least two hydroxyl groups per molecule (e.g., the polyol component may comprise one or more diols (e.g., ethylene glycol or propylene glycol), one or more triols (e.g., glycerine), or a mixture thereof).

A “natural oil” means a triglyceride extracted from renewable raw materials, such as a plant. Examples of natural oils include, for example, castor oil, soybean oil, peanut oil, sunflower oil, rapeseed (canola) oil, palm oil, cottonseed oil, groundnut oil, palm kernel oil, coconut oil, olive oil, corn oil, grape seed oil, linseed oil, safflower oil, sesame oil, maize oil, lesquerella oil, sesame oil, cotton oil, jatropha oil, fish oils such as herring oil or sardine oil, tallow, lard, or a mixture thereof. In certain embodiments, the natural oil is castor oil, soybean oil, or a mixture thereof. In certain other embodiments, the natural oil comprises or is castor oil. In certain other embodiments, the natural oil comprises or is a mixture of castor oil and soybean oil.

An “alkoxylated natural oil” means a natural oil that has been functionalized with groups of the formula -(L-O)ₙ—H or -A-O-(L-O)ₙ—H, where L is a straight or branched C₂₋₃ alkylene group, n is an integer greater than or equal to 1 (e.g., n is selected from integers from 1 to 100), and A is a bond or a divalent linking group). Divalent linking groups can be any suitable chemical group that attaches the remainder of the functional group to the natural oil. Examples of divalent linking groups include C₁₋₆alkylene groups, such as methylene.

Several chemistries known to those skilled in the art can be used to alkoxylate natural oils. Certain natural oils, such as castor oil, comprise triglycerides that contain hydroxylated fatty acids (e.g., ricinoleic acid) and may be alkoxylated without further modification. Other natural oils that do not contain sufficient quantities of hydroxylated fatty acids, but that do contain unsaturated fatty acids may be modified to incorporate hydroxyl groups that may be alkoxylated. The term “alkoxylated natural oil,” as used herein, is intended to encompass both natural oils, such as castor oil, that may be alkoxylated without further modification, and natural oils that must be modified to incorporate hydroxyl groups that can then be alkoxylated. Such modifications include modification at carbon-carbon double bonds to incorporate hydroxyl groups, for example, by epoxidation and nucleophilic ring-opening, hydroxylation, ozonolysis and reduction, and hydroformylation and reduction (to introduce hydroxymethyl groups). Such modifications are commonly known in the art and are described, for example, in U.S. Pat. Nos. 4,534,907, 4,640,801, 6,107,433, 6,121,398, 6,897,283, 6,891,053, 6,962,636, 6,979,477, and PCT publication Nos. WO 2004/020497, WO 2004/096744, WO 2004/096882, and WO 2004/096883.

After the modification of the natural oils, the modified products may be alkoxylated through the use of C₂₋₃alkylene oxides, including ethylene oxide (EO), propylene oxide (PO) and mixtures of EO with PO according to methods familiar to those skilled in the art, such as base catalyzed or acid-catalyzed ring-opening polymerization (see e.g., U.S. Pat. No. 2,870,220; U.S. Pat. No. 2,133,480; U.S. Pat. No. 2,481,278). Alternatively, hydroxyl-containing natural oils or hydroxyl-containing modified natural oils can be alkoxylated by reaction with an alkylene glycol (e.g., ethylene glycol or propylene glycol, or a mixture thereof) or a hydroxy-terminated oligo- and poly(alkylene glycol)s (e.g., hexaethylene glycol, poly(ethylene glycol) with Mn=300 available from Sigma-Aldrich Co., St. Louis, Mo. (Sigma-Aldrich Cat. No. 202371), or poly(ethylene glycol) with Mn=400 available from Sigma-Aldrich Co., St. Louis, Mo. (Sigma-Aldrich Cat. No. 202398) in the presence of a dehydration agent. Suitable reaction conditions are well-known in the art, for example, see U.S. Pat. No. 2,056,830 and EP 2 080 778.

In certain embodiments, the alkoxylated natural oil is ethoxylated (i.e., L is ethylene). In certain embodiments, the ethoxylated natural oil contains an average of about 15 moles to about 50 moles of ethylene oxide per mole of natural oil (e.g., n is about 15 to about 50). In certain other embodiments, the ethoxylated natural oil contains an average of about 25 moles to about 40 moles of ethylene oxide per mole of natural oil (e.g., n is about 25 to about 40). In certain other embodiments, the ethoxylated natural oil contains an average of about 30 moles to about 40 moles of ethylene oxide per mole of natural oil (e.g., n is about 30 to about 40). In certain other embodiments, the ethoxylated natural oil contains an average of about 30 moles to about 36 moles of ethylene oxide per mole of natural oil (e.g., n is about 30 to about 36). In certain other embodiments, the ethoxylated natural oil contains an average of about 36 moles of ethylene oxide per mole of natural oil (e.g., n is about 36). In certain other embodiments, the ethoxylated natural oil contains an average of about 30 moles of ethylene oxide per mole of natural oil (e.g., n is about 30).

In certain embodiments, the polyol component comprises at least 15 wt. % of the C₂₋₃alkoxylated natural oil. In other embodiments, the polyol component comprises at least 20 wt. %, or at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %, at least 80 wt. %, at least 85 wt. %, at least 90 wt. %, at least 95 wt. % of the C₂₋₃alkoxylated natural oil.

In certain other embodiments, the polyol composition, as a whole, comprises at least 10 wt. % of the C₂₋₃alkoxylated natural oil. In other embodiments, the polyol composition comprises at least 10 weight % to about 50 weight % of the C₂₋₃alkoxylated natural oil.

The polyol component may optionally contain additional polyols such as one or more polyalkylene ethers and/or one or more polyester polyols. Polyalkylene ether polyols include the poly(alkylene)oxide polymers such as poly(ethylene)oxide and poly(propylene)oxide polymers and co-polymers thereof having terminal hydroxyl groups derived from polyhydric compounds, including diols and triols, such as ethylene glycol, propylene glycol, 1,3-butanediol, 1,4-butanediol, 1,6-hexanediol, neopentyl glycol, diethylene glycol, dipropylene glycol, pentaerythritol, glycerol, digylcerol, trimethylol propane, cyclohexanediol, and sugars such as sucrose and like low molecular weight polyols. Polyester polyols include those produced when a dicarboxylic acid or lactone is reacted with an excess of a diol or triol (e.g., any of the diols or triols noted above). Examples of polyester polyols include the reaction product of succinic acid, fumaric acid, maleic acid, adipic acid, phthalic acid, isophthalic acid, or terephthalic acid, or succinic anhydride, maleic anhydride, or phthalic anhydride, or caprolactone or a mixture thereof with an excess of ethylene glycol, propylene glycol, or butanediol or a mixture thereof.

In some embodiments, the polyol component comprises at least 15 weight % of the C₂₋₃alkoxylated natural oil, and one or more polyalkylene ether polyols.

While blends of the preceding additional polyols with the C₂₋₃alkoxylated natural oil may be used in the polyol component, in one particular embodiment, the C₂₋₃alkoxylated natural oil is the only polyol component (i.e., the polyol component is 100 wt. % of the C₂₋₃alkoxylated natural oil).

The catalyst is a suitable urethane catalyst, including tertiary amine compounds, amines with isocyanate reactive groups, and organometallic compounds. Exemplary organometallic catalysts include organomercury, organolead, organoferric and organotin catalysts. Other suitable catalysts include one or more members selected from the group consisting of metal catalysts, such as an alkali metal alkoxide such as potassium octoate, stannous octoate, stannous chloride, tin salts of carboxylic acids such as dibutyltin dilaurate, bismuth neodecanoate, and amine compounds, such as triethylenediamine (TEDA), N-methylimidazole, 1,2-dimethylimidazole, N-methylmorpholine, N-ethylmorpholine, trimethylamine, triethylamine, N,N′-dimethylpiperazine, 1,3,5-tris(dimethylaminopropyl)hexahydrotriazine, 2,4,6-tris(dimethylaminomethyl)phenol, N-methyldicyclohexylamine, N,N-dimethylcyclohexylamine, tetramethylethylenediamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, pentamethyldipropylenetriamine, triethanolamine, dimethylethanolamine, bis(dimethylaminoethyl)ether, tris(3-dimethylamino)propylamine, 1,8-diazabicyclo[5.4.0]undecene, bis(N,N-dimethylaminopropyl)-N-methyl amine, 1-methyl-4-dimethylaminoethylpiperazine, 3-methoxy-N-dimethylpropylamine, N-ethylmorpholine, N-cocomorpholine (CAS No. 72906-09-3, a product of BASF SE, Ludwigshafen, Germany), N,N-dimethyl-N′,N′-dimethyl isopropylpropylenediamine, N,N-diethyl-3-diethylamino-propylamine, diethylethanolamine, 3-methoxypropyldimethylamine, N, N, N′-trimethylisopropyl propylenediamine, 3-diethylaminopropyl-diethylamine, and dimethylbenzylamine as well as any mixture thereof. The amount of catalysts can vary from greater than 0 to about 10 percent in the polyol composition, such as about 0.001 to about 10 percent of the polyol composition, or about 0.001 to about 5 percent of the formulation, or about 0.001 to about 2 percent in the polyol composition, or about 0.1 to about 10 percent of the polyol composition, or about 0.1 to about 5 percent of the polyol composition, or about 0.01 to about 2 percent in the polyol composition.

The blowing agent in the polyol compositions generally comprises at least 50 wt. % water. In certain embodiments, the blowing agent comprises at least 60 wt. % water, or at least 70 wt. % water, or at least 80 wt. % water, or at least 90 wt. % water or 100 wt. % water (i.e., water is the only blowing agent in the polyol composition).

Overall, the “B-side” polyol compositions comprise at least 10 wt. % water. In other embodiments, the polyol composition comprises at least 15 wt. % water or at least 20 wt. % water.

Auxiliary blowing agents may be used in combination with water. Examples of auxiliary blowing agents include acetone, ethyl acetate, methyl acetate, diethyl ether, halogen-substituted alkanes, such as hydrofluorocarbon blowing agents (e.g., GENETRON® 245fa [1,1,1,3,3-pentafluoropropane] and GENETRON® 134a (1,1,1,2-tetrafluoroethane), each products of Honeywell Fluorine Products, Morristown, N.J., and SOLKANE® 365mfc [1,1,1,3,3-pentafluorobutane] a product of Solvay Fluor and Derivate GmbH, Hannnover, Germany), hydrocarbon blowing agents (e.g., cyclopentane, isopentane, n-pentane, butane, hexane, and/or heptane), hydrofluoroolefin blowing agents, and mixtures of any of the preceding. Other volatile organic substances may be used as auxiliary blowing agents that vaporize under the influence of the exothermic polymerization reaction (e.g., have a boiling point at standard pressure in the range of from about −40° C. to about 120° C., such as from about 10° C. to about 90° C.).

In one particular embodiment, the polyol composition is substantially free of an emulsifier. “Substantially free” means that the composition contains less than about 1 wt. % of an emulsifier, or less than about 0.5 wt. %, or less than about 0.1 wt. % or less than 0.01 wt. % of an emulsifier, or the composition has 0 wt. % of an emulsifier. “Emulsifier” means alkoxylated alkyl phenol described in WO 00/46266 including those of the formula,

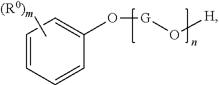

where m is 1, 2, or 3; n is an integer selected from 1-25; R⁰ is C₁₋₂₀ alkyl; and G is C₁₋₂₀ alkylene, and salts and esters thereof; which includes nonylphenolethoxylates of the formula,

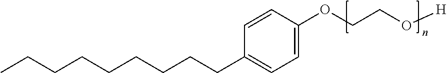

where n is an integer that is one or greater and including regioisomers thereof (i.e., the nonyl group and ethoxylatedphenol groups are ortho- or meta- to one another) and alkylethoxylated alcohols, and ethoxylated fatty alkyl alcohols including those “inventive emulsifiers” described in PCT publication No. WO 2012/021675, of the general structure,

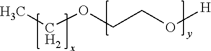

where the lipophilic portion (left-hand side) of the molecules consists of a fatty carbon chain, which may be linear or branched, and contains between 5 and 30 carbons (i.e., x is 4-29) and may contain either petroleum-derived carbon or renewable carbon derived from a natural oil source such as soy, palm, corn, or other renewable source such as biomass. The hydrophilic portion (right-hand side) of the molecule is substantially ethylene oxide, containing between 1 and 40 ethylene oxide repeat units (i.e., y is 1-40), may also comprise minimal amounts of propylene oxide or butylene oxide of not more than about 10% by mass of the overall average molecular weight, and is terminated in a hydroxyl group. Emulsifiers in this disclosure do not include silicone surfactants (i.e., foam stabilizers as described below).

Optional additives which can be used in the “B-side” polyol compositions include:
(a) foam stabilizers, such as silicone surfactants (e.g., TEGOSTAB® B 8408, TEGOSTAB® B 8444, TEGOSTAB® B 8450, TEGOSTAB® B 8453, TEGOSTAB® B 8460, TEGOSTAB® B 8486, TEGOSTAB® B 8487, TEGOSTAB® B 8526, TEGOSTAB® B 8870, TEGOSTAB® is a trademark of Evonik Industries, Essen, Germany); when used, foam stabilizers can be present in an amount from 0.01% to about 10% by weight, preferably about 1% to about 5% by weight, based on the total weight of the components in the B-side;
(b) cell openers, such as VORANOL® Polyol CP 1421 and VORANOL® Polyol 4053 (VORANOL® is a trademark of The Dow Chemical Company, Midland, Mich.); when used, cell openers can be present in an amount from 0.1% to about 8% by weight, such as about 0.1% to about 3% by weight, based on the total weight of the components in the B-side;
(c) flame retardants, such as tris(chloroisopropyl)phosphate, tris(1,3-dichloro-2-propyl)phosphate (TDCPP), tetrakis(2-chloroethyl)dichloroisopentyldiphosphate, melamine, ammonium polyphosphate, pentabromodiphenyl ether, isopropylphenyl diphenyl phosphate, triphenyl phosphate, tribromoneopentyl alcohol, EXOLIT® AP 422, EXOLIT® AP 462, EXOLIT® AP 750, EXOLIT® OP 550, EXOLIT® OP 560, (EXOLIT® is a trademark of Clariant Intl. Ltd., Muttenz, Switzerland); when used, the flameproofing agent can be present in about 2% to about 30% (for example, about 10% to about 20%) by weight, based on the total weight of the components in the B-side;
(d) chain extenders having two isocyanate-reactive groups (e.g., hydroxyl, primary aliphatic or aromatic amine or secondary aliphatic or aromatic amine groups) per molecule and a molecular weight (g/mol) per isocyanate-reactive group of less than 400, such as from about 31 to about 125; examples of chain extenders include amines, ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene; when used, chain extenders can be present in an amount from about 1% to about 20% by weight, such as about 2% to about 10% by weight, based on the total weight of the B-side components;
(e) crosslinking agents having at least 3 functional groups, such as amines or glycols;
(f) reinforcing agents, such as epoxy resins and/or acrylic resins;
(g) fillers, such as recycled polyurethane foam powder;
(h) pigments,
   and any combination of the preceding. Although additives are typically incorporated into the “B-Side” polyol composition, it is understood that they could also be incorporated into the “A-Side” polyisocyanate composition when the additive is compatible with the polyisocyanate.

The polyol compositions described above advantageously are blend stable and/or shelf stable, thereby providing an improvement over polyol compositions available in the art which can suffer from phase separation and/or loss of reactivity upon long-term storage. “Blend stable” or “blend stability” means that the composition remains essentially clear and essentially homogeneous with essentially no separation, when stored at room temperature (e.g., between about 20° C. and about 25° C.) for at least two months, based on visual inspection. “Shelf-stable” means the composition can be stored for at least six months and still retain reactivity when mixed with a polyisocyanate, as measured by an increase in tack-free time of less than 300% with respect to tack-free time for the freshly prepared polyol composition, or an increase in cream time of less than 90% with respect to cream time for the freshly prepared polyol composition.

### Methods for Making Water-Blown Polyurethane Foams

In general, a water-blown polyurethane foam can be prepared by contacting (e.g., mixing or co-spraying) the “A-side” polyisocyanate and “B-side” polyol composition under conditions such that the polyisocyanate and polyol composition react to form a polyurethane polymer. The blowing agent (comprising water) simultaneously generates a gas that expands the reacting mixture. Examples of processes for producing water-blown polyurethane products include, for example, U.S. Pat. No. 6,211,257; U.S. Pat. No. 6,066,681; U.S. Pat. No. 5,627,221; and U.S. Pat. No. 5,420,169.

In certain embodiments, the polyurethane foam may be formed by a prepolymer method in which a stoichiometric excess (on the basis of the isocyanate: hydroxyl contents of the A- and B-sides) of the polyisocyanate is first reacted with the B-side polyol composition described above to form a prepolymer, which is, in a second step, reacted with a chain extender and/or additional “B-side” polyol composition, and/or water to form the desired polyurethane foam.

The foams prepared by the methods described in the application may be “low-density” foams. “Low density” means that the foam has a density of about 0.3 lb/ft³ (about 4.8 kg/m3) to about 1.9 lb/ft³ (about 30.5 kg/m³). Such low density foams include “½-lb” foams suitable for insulation applications as barriers in buildings (e.g., residential wall and attic applications) that have a density of about 0.4 lb/ft³ (about 6.40 kg/m³) to about 0.6 lb/ft³ (about 9.61 kg/m³). Low density foams are typically formed from B-side polyol compositions that comprise water as a blowing agent, and one or more high molecular weight polyoxyalkylene polyether polyols, such as polyether triols, as a majority of the polyol component. Aromatic polyester polyols are not used in these types of formulations due to their propensity for hydrolysis in high water systems. The B-side polyol compositions also typically comprise one or more emulsifiers, such as nonylphenolethoxylates, to compatibilize the polyether polyols with the water blowing agent. Surprisingly, C₂₋₃alkoxylated natural oil can be used as a 1:1 replacement for both the polyether polyols and the emulsifiers typically required to obtain a homogeneous composition. Thus, in the compositions of the present technology, the C₂₋₃alkoxylated natural oil can function as both a polyol component and as a compatibilizer for the water blowing agent to achieve B-side polyol compositions that are blend stable and shelf stable.

“Polyisocyanate” means a compound or mixture of compounds each having at least two isocyanate functional groups per molecule. Examples of polyisocyanates useful in the process of preparing polyurethane foams are well-known in the art, and are selected from, for instance, aliphatic, cycloaliphatic, and aromatic polyisocyanates, and combinations thereof. Examples of polyisocyanates include at least one member selected from the group consisting of 4,4′-, 2,4′ and 2,2′-isomers of diphenylmethane diisocyante (MDI), blends thereof and polymeric and monomeric MDI blends, hydrated MDI, 1,5-naphthalene diisocyanate, toluene-2,4- and 2,6-diisocyanates (TDI)(e.g., 2,4-TDI, 2,6-TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate, diphenyletherdiisocyanate, 2,4,6-triisocyanatotoluene, 2,4,4′-triisocyanatodiphenylether, ethylene diisocyanate, 1,6-hexamethylene diisocyanate, isophorone diisocyanate, cyclohexane 1,4-diisocyanate, 4,4′-dicyclohexylmethane diisocyanate, 2,4-methoxyphenyl diisocyanate, 4,4′-biphenylene diisocyanate, 3,3′-dimethoxy-4,4′-biphenylene diisocyanate, 3,3′-dimethyl-4,4′-biphenylene diisocyanate, 3,3′-dimethyl-4,4′-diphenylmethane diisocyanate; 4,4′4″-triphenylmethane triisocyanate, 2,4,6-toluene triisocyanate; 4,4′-dimethyl-2,2′,5,5′-diphenylmethane tetraisocyanate; polymethylenepolyphenylene polyisocyanate, and mixtures thereof. For example, 2,4-TDI, 2,6-TDI, and mixtures thereof, can be used. TDI/MDI blends may also be used. Crude polyisocyanates may also be used, such as crude toluene diisocyanate obtained by the phosgenation of a mixture of toluene diamine or the crude diphenylmethane diisocyanate obtained by the phosgenation of crude methylene diphenylamine.

In another embodiment, prepolymers of polyisocyanates comprising a partially pre-reacted mixture of polyisocyanates and polyether or polyester polyol are suitable. In still another aspect, the polyisocyanate comprises MDI, or consists essentially of MDI or mixtures of MDIs. For example, PAPI™ polyisocyanates, such as PAPI™ 27, PAPI™ 901, and PAPI™ 94 (Dow Automotive Systems, Auburn Hills, Mich.) may be used. PAPI™ polyisocyanates are polymethylene polyphenylisocyanates that contain MDI (i.e., contain 4,4′-diphenylmethane diisocyanate) along with other isomeric and analogous higher polyisocyanates.

In another aspect, this disclosure provides the water-blown polyurethane foam prepared according to the preceding aspects and any embodiment thereof.

In another aspect, this disclosure provides kits comprising a first container that contains the polyol composition according to preceding aspects and any embodiment thereof and a second container that contains a polyisocyanate according to preceding aspects and any embodiment thereof. Suitable containers (i.e., first and second containers) include chemical-resistant glass and polymeric bottles, jerricans, and drums, such as polyethylene-based and poly(tetrafluoroethylene)-based containers, and containers having a chemical-resistant liner, such as 55-gallon or 85-gallon steel or plastic drums, including steel drums that comply with the Hazardous Materials Regulations (HMR) for steel drums (49 C.F.R. § 178.504) and plastic drums and jerricans that comply with 49 C.F.R. § 178.509.

### Definitions

“About” means+/−10% of the referenced value. In certain embodiments, about means+/−5% of the referenced value, or +/−4% of the referenced value, or +/−3% of the referenced value, or +/−3% of the referenced value, or +/−2% of the referenced value, or +/−1% of the referenced value

The term “alkyl” means a straight or branched chain saturated hydrocarbon containing from 1 to 6 carbon atoms (e.g., 1 to 4 carbon atoms), unless otherwise defined. Representative examples of alkyl include methyl, ethyl, n-propyl, iso-propyl, n-butyl, sec-butyl, iso-butyl, and tert-butyl. When an “alkyl” group is a linking group between two other moieties it can be referred to as an “alkylene” group, that may also be a straight or branched chain; examples of “alkylene” groups include —CH₂—, —CH₂CH₂—, and —CH₂CH₂CH(CH₃).

Chemical terms may be preceded and/or followed by a single dash to indicate the bond order of the bond between the named substituent and its parent moiety and indicates a single bond. In the absence of a single dash it is understood that a single bond is formed between the substituent and its parent moiety. Further, substituents are intended to be read “left to right” unless a dash indicates otherwise. For example, C₁-C₆alkoxy and —OC₁-C₆alkyl indicate the same functionality. Further, certain terms herein may be used as both monovalent and divalent linking radicals as would be familiar to those skilled in the art, and by their presentation linking between two other moieties. For example, an alkyl group can be both a monovalent radical or divalent radical; in the latter case, it would be apparent to one skilled in the art that an additional hydrogen atom is removed from a monovalent alkyl radical to provide a suitable divalent moiety (e.g., an alkylene, supra).

While specific embodiments and the following examples have been described in detail, those with ordinary skill in the art will appreciate that various modifications and alternatives to those details could be developed in light of the overall teachings of the disclosure. Accordingly, the particular arrangements and examples disclosed are meant to be illustrative only and not limiting as to the scope of the invention, which is to be given the full breadth of the appended claims, and any and all equivalents thereof. Unless otherwise defined, all technical and scientific terms used herein have the same meaning as commonly understood by one of ordinary skill in the art to which this invention pertains. All references mentioned herein, including publications, patent applications, and patents, are incorporated by reference in their entirety. In addition, the following examples are only illustrative and not intended to be limiting.

### EXAMPLES

### Example 1 Ethoxylated Oil as a Polyether Replacement

To determine the viability of using high levels of ethoxylated oil as a polyether replacement, blends were made using a conventional petroleum-based polyether triol as a control, and two natural oil polyols in accordance with the present technology. The polyether triol is an alkoxylated triol having a molecular weight of 4,800 and an OH value of 32 to 38. Natural oil polyol 1 is an alkoxylated castor oil having a nominal functionality of 2.7. Natural oil polyol 2 is an alkoxylated mixture of castor oil and soybean oil having a nominal functionality of 2.0. Each blend produced a low density foam with similar reactivity and density and all foams remained stable in the cup overnight (no shrinkage). See Table 1 for details on the blends and reactivity performance. In this formulation, the nonylphenolethoxylate (MAKON® 10, CAS No. 9016-45-9, Stepan Company, Northfield, Ill.) remains, so that only one variable is changed at a time.

TABLE 1
Replacing Polyether Triol with Ethoxylated Vegetable Oil

| | Trial 1 | Trial 2 | Trial 3 |
|---|---|---|---|
| | Polyether | Natural oil | Natural Oil |
| B side ingredients % | triol | Polyol 1 | Polyol 2 |
| Polyether Triol | 29 | | |
| Natural oil Polyol 1 | | 29 | |
| Natural oil Polyol 2 | | | 29 |
| Additional polyether | 22 | 22 | 22 |
| polyols/polyester | | | |
| polyols | | | |
| Saytex ® RB 79-80 | 11 | 11 | 11 |
| Fyrol ® PCF | 14 | 14 | 14 |
| MAKON ® 10 | 5 | 5 | 5 |
| TEGOSTAB ® | 3 | 3 | 3 |
| B-8870 | | | |
| Water | 14.3 | 14.3 | 14.3 |
| JEFFCAT ® ZF-20 | 1.5 | 1.5 | 1.5 |
| DABCO ® K-15 | 0.2 | 0.2 | 0.2 |
| Total | 100.00 | 100.00 | 100.00 |
| Total Equivalents | 1.752 | 1.769 | 1.769 |
| Isocyanate Type | MR Light | MR Light | MR Light |
| Isocyanate Equiv. | 133 | 133 | 133 |
| Index (NCO/OH) | 50 | 49 | 49 |
| Wt Ratio (A/B) | 1.16 | 1.15 | 1.15 |
| Parts by Wt. A | 53.8 | 53.6 | 53.6 |
| Parts by Wt. B | 46.2 | 46.4 | 46.4 |

Initial Hand Mix: Mix 50 g system in a one quart cup for 3 sec

| | | | |
|---|---|---|---|
| Total Wt in Cup (g): | 50 | 50 | 50 |
| Condition to 77° F. | 27 grams | 27 grams | 27 grams |
| Wt. A-side | | | |
| Condition to 77° F. | 23 grams | 23 grams | 23 grams |
| Wt. B-side | | | |
| Cream Time (sec.) | 6 | 6 | 6 |
| Tack-Free Time (sec.) | 25 | 20 | 21 |
| Cup Density, P4325 (pcf) | 1.10 | 1.26 | 1.17 |

Saytex ® RB 79-80 is a brominated reactive diol flame retardant, Albemarle, Baton Rouge, Louisana
Fyrol ® PCF is tris (2-chloroisopropyl) phosphate flame retardant, ICL Industrial Products, Tel Aviv, Israel
MAKON ®10 is a nonylphenol ethoxylate, Stepan Company, Northfield, Illinois
TEGOSTAB ® B-8870 is a silicone surfactant, Evonik Goldschmidt Corp., Hopewell, Virginia
JEFFCAT ® ZF-20 is Bis-(2-dimethylaminoethyl)ether, Huntsman Corp., The Woodlands, Texas.
DABCO ® K-15 is potassium octoate, Air Products, Allentown, Pennsylvania

### Example 2 Blend Clarity and Stability

To evaluate the effectiveness of the natural oil polyol as a replacement for both the polyether polyol and the alkyl phenol ethoxylate emulsifier components, the following work was done using the same half pound foam formulation but with the MAKON® 10 emulsifier removed. Two similar polyether triols were used as controls in the study: the conventional polyether polyol from Example 1 (Polyether Triol 1), (Trials 4 & 5) and a glycerine and propylene oxide-based polyether triol having a molecular weight of about 5000 (Polyether Triol 2) (Trial 6). The Polyether triol controls were compared to Natural Oil Polyol 1 (Trial 7) and Natural Oil Polyol 2 from Example 1 (Trial 8). The polyether blends without emulsifier—Trials 5 & 6—became hazy and separated within 2 months while the blends made with Natural Oil Polyol 1 and Natural Oil Polyol 2—Trials 7 & 8—remained clear. See Table 2. These results demonstrate that the natural oil polyol of the present technology provides a homogenous and stable blend without the need for any emulsifier, while the polyether polyol of the prior art requires an emulsifier to maintain a shelf stable blend.

TABLE 2
Effect of Removing Nonyl Phenol Ethoxylate on Blend Clarity, Stability

| | Trial 4 | Trial 5 | | Trial 7 | Trial 8 |
|---|---|---|---|---|---|
| B side | Polyether | Polyether | | Natural Oil | Natural Oil |
| ingredients % | Triol | Triol | Trial 6 | Polyol 1 | Polyol 2 |
| Polyether Triol 1 | 29 | 34 | | | |
| Polyether Triol 2 | | | 34 | | |
| Natural Oil Polyol | | | | 34 | |
| 1 | | | | | |
| Natural Oil Polyol | | | | | 34 |
| 2 | | | | | |
| Additional | 22 | 22 | 22 | 22 | 22 |
| polyether | | | | | |
| polyols/ | | | | | |
| polyester | | | | | |
| polyols | | | | | |
| MAKON ® 10 | 5 | 0 | 0 | 0 | 0 |
| Saytex ® RB 79-80 | 11 | 11 | 11 | 11 | 11 |
| Fryol ®PCF | 14 | 14 | 14 | 14 | 14 |
| TEGOSTAB ® B- | 3 | 3 | 3 | 3 | 3 |
| 8870 | | | | | |
| Water | 14.3 | 14.3 | 14.3 | 14.3 | 14.3 |
| JEFFCAT ® ZF-20 | 1.5 | 1.5 | 1.5 | 1.5 | 1.5 |
| DABCO ® K-15 | 0.2 | 0.2 | 0.2 | 0.2 | 0.2 |
| Total | 100.00 | 100.00 | 100.00 | 100.00 | 100.00 |
| Blend Clarity, | | | | | |
| Stability | | | | | |
| Is blend clear? | (Initial, | (Initial, | (Initial, | (Initial, | (Initial, |
| Is blend | 0 h): | 0 h): | 0 h): | 0 h): | 0 h): |
| homogeneous? | clear, no | milky/hazy, | milky/hazy, | clear, no | clear, no |
| Other | separation | no | no | separation | separation |
| observations? | 24 h.: | separation | separation | 24 h.: | 24 h.: |
| | clear, no | 24 h.: | 24 h.: | clear, no | clear, no |
| | separation | milky/hazy, | milky/hazy, | separation | separation |
| | 2 Mo.: | no | no | 2 Mo.: | 2 Mo.: |
| | clear, no | separation | separation | clear, no | clear, no |
| | separation | 2 Mo.: | 2 Mo.: | separation | separation |
| | | hazy with | hazy with | | |
| | | clear layer | clear layer | | |
| | | on top | on top | | |

### Example 3 Shelf Life

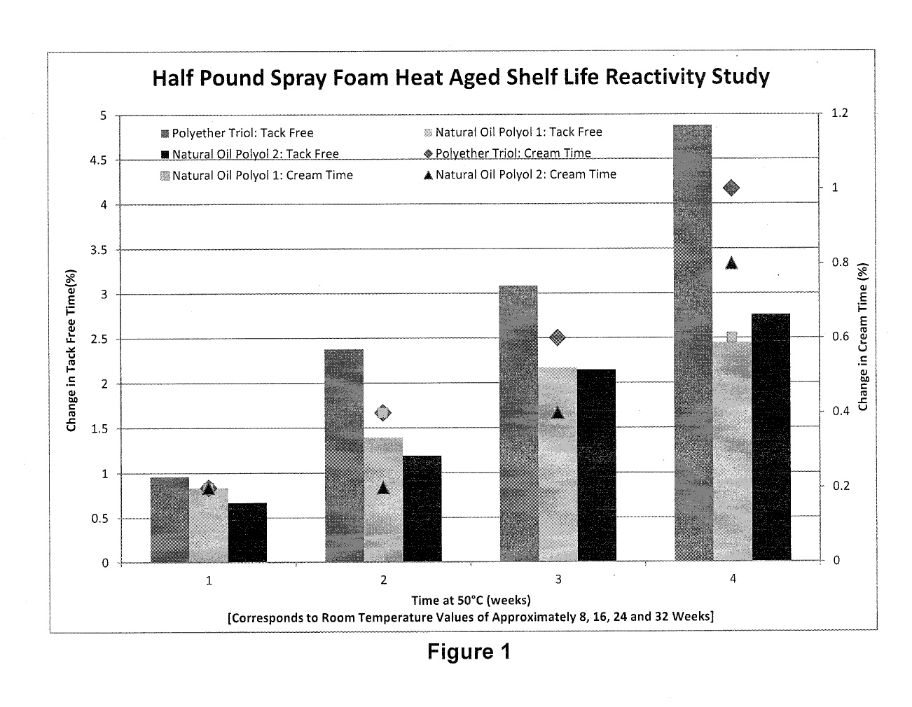

To evaluate the effectiveness of the ethoxylated oil to improve the shelf life of the system, a heat aging study was done. Samples from Table 1 were stored in a 50° C. oven and tested weekly for reactivity. Four weeks of testing at 50° C. equates to roughly 32 weeks at room temperature. Many half pound manufacturers only guarantee a three month shelf life. The data shows that both Natural Oil Polyol 1 and Natural Oil Polyol 2 have significantly better shelf life, even after only 1 week of aging. See FIG. 1.

The present technology is now described in such full, clear, concise, and exact terms as to enable any person skilled in the art to which it pertains, to practice the same. It is to be understood that the foregoing describes preferred embodiments of the invention and that modifications may be made therein without departing from the spirit or scope of the invention as set forth in the appended claims.

We claim:

1. A polyol composition for preparing a water-blown polyurethane foam, comprising (a) a polyol component comprising a C₂₋₃alkoxylated natural oil, (b) a catalyst, and (c) a blowing agent comprising at least 50 wt. % water, wherein the polyol composition comprises at least 10 wt. % of the C₂₋₃alkoxylated natural oil.

2. The polyol composition of claim 1 that is substantially free of an emulsifier.

3. The polyol composition of claim 1 comprising from 10 weight % to 50 weight % of the C₂₋₃alkoxylated natural oil.

4. The polyol composition of claim 1 comprising at least about 10 wt. % water.

5. The polyol composition of claim 1, wherein the natural oil is castor oil, soybean oil, peanut oil, sunflower oil, rapeseed oil, palm oil, cottonseed oil, groundnut oil, palm kernel oil, coconut oil, olive oil, corn oil, grape seed oil, linseed oil, safflower oil, sesame oil, maize oil, lesquerella oil, sesame oil, cotton oil, jatropha oil, fish oil, herring oil, sardine oil, tallow, lard, or a mixture thereof.

6. The polyol composition of claim 5, wherein the natural oil is castor oil, soybean oil, or a mixture thereof.

7. The polyol composition of claim 5, wherein the natural oil is castor oil.

8. The polyol composition of claim 5, wherein the natural oil is a mixture of castor oil and soybean oil.

9. The polyol composition of claim 1, wherein the natural oil is ethoxylated.

10. The polyol composition of claim 9, wherein the ethoxylated natural oil contains an average of about 15 moles to about 50 moles of ethylene oxide per mole of natural oil.

11. The polyol composition of claim 1, comprising one or more additional components selected from the group consisting of flame retardants, silicone surfactants, cell openers, chain extenders, crosslinkers, reinforcing agents, fillers, and pigments.

12. The polyol composition of claim 1, wherein the polyol component comprises a blend of the C₂₋₃ alkoxylated natural oil and one or more additional polyols, and the C₂₋₃ alkoxylated natural oil comprises at least 15 weight % of the polyol component.

13. The polyol composition of claim 12, wherein the one or more additional polyols are selected from polyalkylene ether polyols and polyester polyols.

14. The polyol composition of claim 1, wherein the C₂₋₃ alkoxylated natural oil is the only polyol component.

15. The polyol composition of claim 1, wherein the water is the only blowing agent in the polyol composition.

16. The polyol composition of claim 1, wherein the polyol composition is shelf-stable for at least 6 months.

17. The polyol composition of claim 1, wherein the polyol composition is blend stable for at least 6 months.

18. A method for preparing a water-blown polyurethane foam comprising contacting a polyol composition according to claim 1 with a polyisocyanate composition comprising a polyisocyanate under conditions suitable to form a polyurethane foam.

19. The method of claim 18, wherein the polyisocyanate is selected from the group consisting of 4,4′-diphenylmethane diisocyante, 2,4′-diphenylmethane diisocyante, 2,2′-diphenylmethane diisocyante, 1,5-naphthalene diisocyanate, toluene-2,4-diisocyanate (2,4-TDI), toluene-2,6-diisocyanates (2,6-TDI), m-phenylenediisocyanate, p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate, diphenyletherdiisocyanate, 2,4,6-triisocyanatotoluene, 2,4,4′-triisocyanatodiphenylether, ethylene diisocyanate, 1,6-hexamethylene diisocyanate, isophorone diisocyanate, cyclohexane 1,4-diisocyanate, 4,4′-dicyclohexylmethane diisocyanate, 2,4-methoxyphenyl diisocyanate, 4,4′-biphenylene diisocyanate, 3,3′-dimethoxy-4,4′-biphenylene diisocyanate, 3,3′-dimethyl-4,4′-biphenylene diisocyanate, 3,3′-dimethyl-4,4′-diphenylmethane diisocyanate; 4,4′4″-triphenylmethane triisocyanate, 2,4,6-toluene triisocyanate; 4,4′-dimethyl-2,2′,5,5′-diphenylmethane tetraisocyanate; polymethylenepolyphenylene polyisocyanate, and mixtures thereof.

20. The method of claim 18, wherein the polyisocyanate comprises a mixture of at least two polyisocyanates selected from the group consisting of 4,4′-diphenylmethane diisocyante, 2,4′-diphenylmethane diisocyante, 2,2′-diphenylmethane diisocyante, toluene-2,4-diisocyanate (2,4-TDI), and toluene-2,6-diisocyanates (2,6-TDI).

21. The method of claim 18, wherein the polyisocyanate comprises a prepolymer comprising a reaction product of an excess of a polyisocyanate with a polyol comprising a polyether polyol, a polyester polyol, or a mixture thereof, wherein the excess is calculated based on the isocyanate content of the polyisocyanate with respect to the hydroxyl content of the polyol.
